(19) United States
(12) Patent Application Publication
(10) Pub. No.: US 2025/0167498 A1
(43) Pub. Date: May 22, 2025

(54) CONNECTOR ASSEMBLY

(71) Applicant: Japan Aviation Electronics Industry, Limited, Tokyo (JP)

(72) Inventor: Osamu HASHIGUCHI, Tokyo (JP)

(21) Appl. No.: 18/887,213

(22) Filed: Sep. 17, 2024

(30) Foreign Application Priority Data
Nov. 16, 2023 (JP) 2023-195180

(51) Int. Cl. H01R 24/84; H01R 13/52; H01R 13/631

(52) U.S. Cl. CPC H01R 24/84; H01R 13/631; H01R 13/5219

(57) ABSTRACT

A connector assembly includes a first connector and a second connector having an identical configuration, the first connector including a first insulator, and a first contact retained by the first insulator and connected to an end portion of a first electric wire, the second connector including a second insulator, and a second contact retained by the second insulator and connected to an end portion of a second electric wire, when the first connector and the second connector are fitted with each other, the first contact and the second contact make contact with each other in a state where part of the first contact is situated between the second contact and the second insulator and part of the second contact is situated between the first contact and the first insulator, whereby the first electric wire and the second electric wire are electrically connected to each other.

### BACKGROUND OF THE INVENTION

The present invention relates to a connector assembly, particularly to a connector assembly in which a first connector and a second connector are fitted with each other, the first connector being joined to an end portion of a first electric wire, and the second connector being joined to an end portion of a second electric wire and having the same configuration as that of the first connector.

Conventionally, there has been known a connector for connecting two electric wires to each other.

For instance, JPH 8-55657 A discloses a connector assembly that connects a plurality of electric wires to one another by fitting a first connector 1 and a second connector 2 with each other, as shown in FIG. 31. The first connector 1 and the second connector 2 have the same configuration and are each hermaphroditically formed.

The first connector 1 includes a first insulator 3 and a plurality of first contacts 4 retained in the first insulator 3. The first insulator 3 includes a blade portion 3A of flat plate shape which extends forward in the first connector 1 and on which the plurality of first contacts 4 are disposed, and a pair of guide portions 3B that are adjacent to opposite lateral portions of the blade portion 3A and extend forward in a plane different from a plane in which the blade portion 3A extends.

As with the first connector 1, the second connector 2 includes a second insulator 5 and a plurality of second contacts 6 (not shown) retained in the second insulator 5. The second insulator 5 includes a blade portion 5A of flat plate shape which extends forward in the second connector 2 and on which the plurality of second contacts 6 are disposed, and a pair of guide portions 5B that are adjacent to opposite lateral portions of the blade portion 5A and extend forward in a plane different from a plane in which the blade portion 5A extends.

As shown in FIG. 31, when the first connector 1 and the second connector 2 are inserted into each other while facing in longitudinally, horizontally, and vertically opposite directions, the blade portion 3A and the blade portion 5A are superposed on each other, and the pair of guide portions 3B and the pair of guide portions 5B are superposed on each other to make contact with each other, whereby the fitted state is established between the first connector 1 and the second connector 2.

Thus, as shown in FIG. 32, a contacting portion 4A of each of the first contacts 4 disposed at the blade portion 3A and a contacting portion 6A of each of the second contacts 6 disposed at the blade portion 5A elastically contact each other, and the plurality of first contacts 4 and the plurality of second contacts 6 are electrically connected with each other.

When the contacting portion 4A of each of the plurality of first contacts 4 and the contacting portion 6A of each of the plurality of second contacts 6 elastically contact each other, the first connector 1 and the second connector 2 receive forces exerted in directions away from each other; however, the pair of guide portions 3B and the pair of guide portions 5B shown in FIG. 31 face each other and make contact with each other, whereby the fitted state between the first connector 1 and the second connector 2 is maintained.

However, in order to maintain the fitted state between the first connector 1 and the second connector 2 against the forces generated due to the elastic contact between the plurality of first contacts 4 and the plurality of second contacts 6, it is necessary to secure the strength of the pair of guide portions 3B of the first connector 1 and the strength of the pair of guide portions 5B of the second connector 2, causing a problem that it is difficult to reduce the size of each of the first connector 1 and the second connector 2.

### SUMMARY OF THE INVENTION

The present invention has been made in order to solve the conventional problem described above and is aimed at providing a connector assembly capable of reducing the size thereof while electric wires are connected to each other by means of a first connector and a second connector that have the same configuration.

A connector assembly according to the present invention is one in which a first connector and a second connector are fitted with each other, the first connector being joined to an end portion of a first electric wire, and the second connector being joined to an end portion of a second electric wire and having a same configuration as that of the first connector,

wherein the first connector includes a first insulator, and a first contact retained by the first insulator and connected to the end portion of the first electric wire,

the second connector includes a second insulator, and a second contact retained by the second insulator and connected to the end portion of the second electric wire, and

when the first connector and the second connector are fitted with each other, the first contact and the second contact make contact with each other in a state where part of the first contact is situated between the second contact and the second insulator and part of the second contact is situated between the first contact and the first insulator, whereby the first electric wire and the second electric wire are electrically connected to each other.

### BRIEF DESCRIPTION OF THE DRAWINGS

FIG. 1 is a perspective view showing a connector assembly of Embodiment 1 in a fitted state.

FIG. 2 is a plan view showing the connector assembly of Embodiment 1 in the fitted state.

FIG. 3 is a side view showing the connector assembly of Embodiment 1 in the fitted state.

FIG. 4 is a perspective view showing the connector assembly of Embodiment 1 in a non-fitted state.

FIG. 5 is an assembly view of a first connector in the connector assembly of Embodiment 1.

FIG. 6 is a perspective view showing a first insulator of the first connector in Embodiment 1.

FIG. 7 is a perspective view showing a first contact of the first connector in Embodiment 1.

FIG. 8 is a plan view showing the first connector in Embodiment 1.

FIG. 9 is a cross-sectional view taken along line B-B in FIG. 8.

FIG. 10 is a cross-sectional view showing a second connector in Embodiment 1 and corresponding to FIG. 9.

FIG. 11 is a perspective view showing the connector assembly of Embodiment 1 before the first connector and the second connector are linearly slid.

FIG. 12 is a side view showing the connector assembly of Embodiment 1 before the first connector and the second connector are linearly slid.

FIG. 13 is a cross-sectional side view showing the connector assembly of Embodiment 1 before the first connector and the second connector are linearly slid.

FIG. 14 is a cross-sectional view taken along line A-A in FIG. 2.

FIG. 15 is an enlarged partial view showing a first locking portion and a second locked portion of the connector assembly of Embodiment 1 in the fitted state.

FIG. 16 is a perspective view showing a connector assembly of Embodiment 2 in the fitted state.

FIG. 17 is a plan view showing the connector assembly of Embodiment 2 in the fitted state.

FIG. 18 is a side view showing the connector assembly of Embodiment 2 in the fitted state.

FIG. 19 is a perspective view showing the connector assembly of Embodiment 2 in a non-fitted state.

FIG. 20 is an assembly view of a first connector in the connector assembly of Embodiment 2.

FIG. 21 is a perspective view showing a first insulator of the first connector in Embodiment 2.

FIG. 22 is a perspective view showing a first contact of the first connector in Embodiment 2.

FIG. 23 is a plan view showing the first connector in Embodiment 2.

FIG. 24 is a cross-sectional view taken along line D-D in FIG. 23.

FIG. 25 is a cross-sectional view showing a second connector in Embodiment 2 and corresponding to FIG. 24.

FIG. 26 is a perspective view showing the connector assembly of Embodiment 2 before the first connector and the second connector are rotated and slid.

FIG. 27 is a side view showing the connector assembly of Embodiment 2 before the first connector and the second connector are rotated and slid.

FIG. 28 is a cross-sectional side view showing the connector assembly of Embodiment 2 before the first connector and the second connector are rotated and slid.

FIG. 29 is a cross-sectional view taken along line C-C in FIG. 17.

FIG. 30 is an enlarged partial view showing a first locking portion and a second locked portion of the connector assembly of Embodiment 2 in the fitted state.

FIG. 31 is a perspective view showing a conventional connector assembly in a non-fitted state.

FIG. 32 is a cross-sectional view showing the conventional connector assembly in a fitted state.

### DETAILED DESCRIPTION OF THE INVENTION

Embodiments of the present invention are described below based on the accompanying drawings.

### Embodiment 1

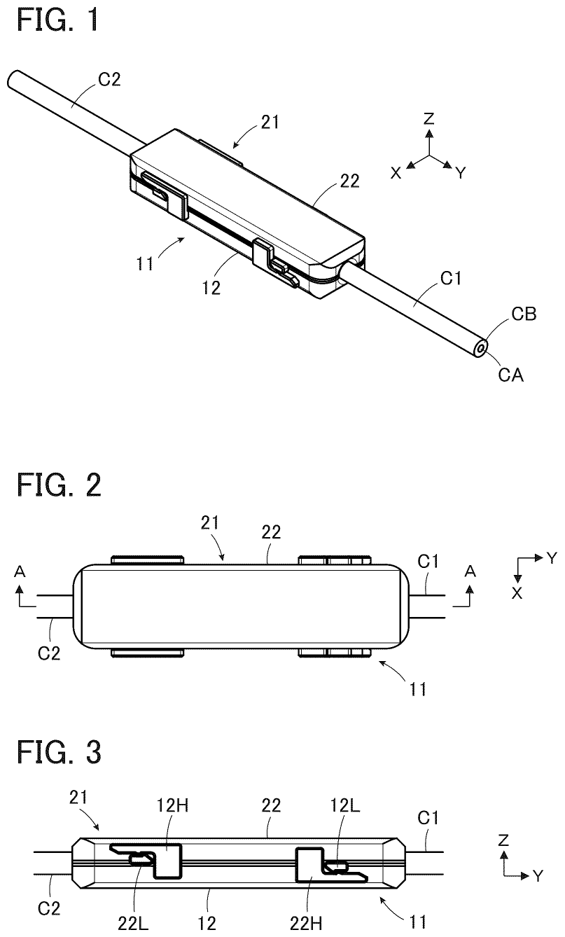

FIGS. 1 to 3 show a connector assembly according to Embodiment 1. The connector assembly includes a first connector 11 and a second connector 21, and when the second connector 21 is linearly slid relatively to the first connector 11, the first connector 11 and the second connector 21 are fitted with each other, and a first electric wire C1 and a second electric wire C2 are electrically connected to each other.

The first connector 11 is joined to an end portion of the first electric wire C1, while the second connector 21 is joined to an end portion of the second electric wire C2. The first electric wire C1 and the second electric wire C2 are each formed of a coated electric wire in which an outer periphery of a conductor portion CA is covered with an insulating coating portion CB, and extend in opposite directions from each other on the same straight line.

The first connector 11 includes a first insulator 12 extending in a direction in which the first electric wire C1 extends, while the second connector 21 includes a second insulator 22 extending in a direction in which the second electric wire C2 extends. The first connector 11 and the second connector 21 are fitted with each other with the second insulator 22 being superposed on the first insulator 12.

For convenience, a direction from the first connector 11 toward the second connector 21 in a fitted state between the first connector 11 and the second connector 21 is referred to as “+Z direction,” a direction in which the first electric wire C1 and the second electric wire C2 extend “Y direction,” and a width direction of each of the first insulator 12 and the second insulator 22, that is, a direction orthogonal to a YZ plane “X direction.”

The first connector 11 and the second connector 21 have the same configuration, and the first connector 11 is joined to a −Y directional end portion of the first electric wire C1, while the second connector 21 is joined to a +Y directional end portion of the second electric wire C2.

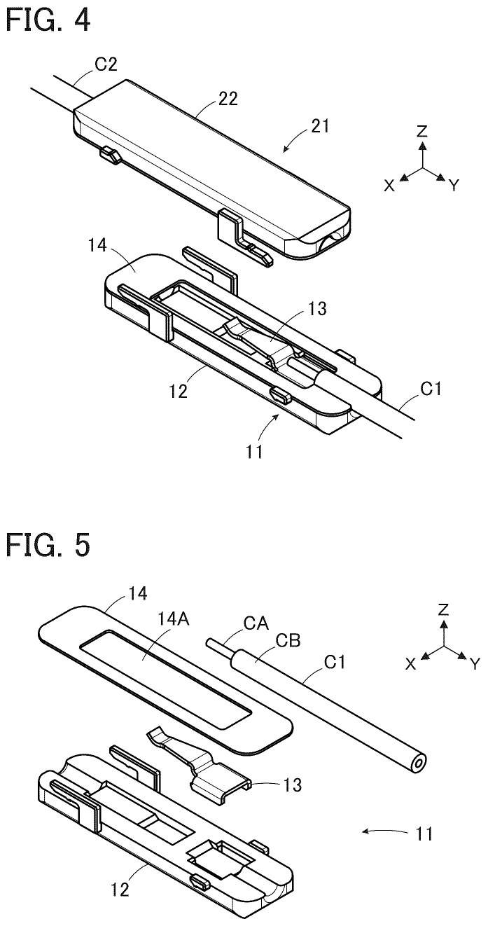

FIG. 4 shows the connector assembly of Embodiment 1 in a non-fitted state. The first connector 11 and the second connector 21 have the same configuration and are each hermaphroditically formed. The second connector 21 is fitted with the first connector 11 while oppositely facing in the X direction, the Y direction, and the Z direction from the first connector 11.

FIG. 5 shows an assembly view of the first connector 11. A first contact 13 is disposed on the +Z direction side of the first insulator 12, a first waterproof sheet 14 is disposed on the +Z direction side of the first contact 13, and the first electric wire C1 is disposed on the +Z direction side of the first waterproof sheet 14.

The first waterproof sheet 14 has a shape corresponding to an outer shape of the first insulator 12 when viewed from the +Z direction and is provided at the center thereof with a rectangular opening portion 14A extending in the Y direction. In addition, at the −Y directional end portion of the first electric wire C1, the insulating coating portion CB is removed to expose the conductor portion CA, and the exposed conductor portion CA of the first electric wire C1 is situated on the +Z direction side of the first contact 13 via the opening portion 14A of the first waterproof sheet 14.

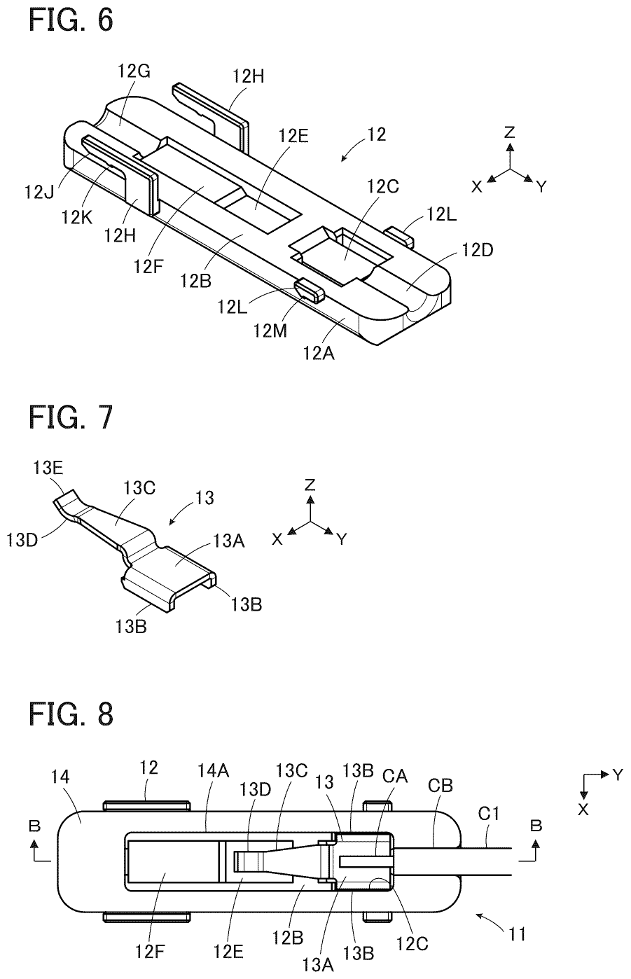

As shown in FIG. 6, the first insulator 12 is made of an insulating resin and includes a flat plate portion 12A of substantially rectangular shape extending in the Y direction along an XY plane. The flat plate portion 12A has a first joining surface 12B of planar shape facing in the +Z direction, and a recessed portion 12C opening in the +Z direction is formed in the first joining surface 12B at a position deviated to the +Y direction side from the Y directional center of the flat plate portion 12A.

In addition, the first joining surface 12B is provided with a first electric wire accommodating groove 12D extending in the Y direction from the recessed portion 12C to a +Y directional end portion of the first insulator 12.

Further, the first joining surface 12B is provided with a recessed portion 12E disposed at the Y directional center of the first insulator 12 and opening in the +Z direction, a communication groove 12F communicating with the recessed portion 12E and extending in the −Y direction from the recessed portion 12E, and a second electric wire accommodating groove 12G extending in the Y direction from the communication groove 12F to a −Y directional end portion of the first insulator 12.

The recessed portion 12C is configured to accommodate part of the first contact 13 to retain the first contact 13, and the recessed portion 12E is configured to accommodate a contacting portion between the first contact 13 and a second contact 23, to be described later, of the second connector 21 when the first connector 11 and the second connector 21 are fitted to each other. The recessed portions 12C and 12E form a first contact accommodating portion of recess shape disposed in the first joining surface 12B.

The periphery of these recessed portions 12C and 12E is completely surrounded by the first joining surface 12B of planar shape, the first electric wire accommodating groove 12D and the second electric wire accommodating groove 12G.

At opposite lateral portions of the flat plate portion 12A on the +X direction side and the −X direction side of the communication groove 12F, a pair of L-shaped first locking portions 12H are separately formed to overhang outward in the X direction from the flat plate portion 12A and protrude in the +Z direction. Each first locking portion 12H includes an arm portion 12J extending in the −Y direction on the +Z direction side from the first joining surface 12B, and a projection 12K protruding in the −Z direction from an intermediate portion of the arm portion 12J.

In addition, at opposite lateral portions of the flat plate portion 12A on the +X direction side and the −X direction side of the recessed portion 12C, a pair of first locked portions 12L are separately formed to overhang outward in the X direction from the flat plate portion 12A. The first locked portion 12L is provided with a projection 12M protruding in the −Z direction.

As shown in FIG. 7, the first contact 13 is formed of a metal sheet having conductivity and being bent and includes an electric wire connection portion 13A of substantially rectangular shape extending along an XY plane, and a pair of leg portions 13B being bent in the −Z direction separately from a +X directional end portion and a −X directional end portion of the electric wire connection portion 13A.

Further, the first contact 13 includes an extending portion 13C once projecting in the +Z direction from a −Y directional end portion of the electric wire connection portion 13A and then extending in the −Y direction, and at a −Y directional end portion of the extending portion 13C, a first protrusion portion 13D is formed to be curved so as to protrude in the −Z direction. A −Y directional tip portion 13E of the first protrusion portion 13D is inclined in the −Y direction and the +Z direction.

As shown in FIG. 8, in the first connector 11, the pair of leg portions 13B of the first contact 13 are press-fitted into the recessed portion 12C, which forms part of the first contact accommodating portion, of the first insulator 12, whereby the first contact 13 is retained by the first insulator 12. In addition, the first waterproof sheet 14 made of a rubber material or the like is disposed on the first joining surface 12B of the first insulator 12.

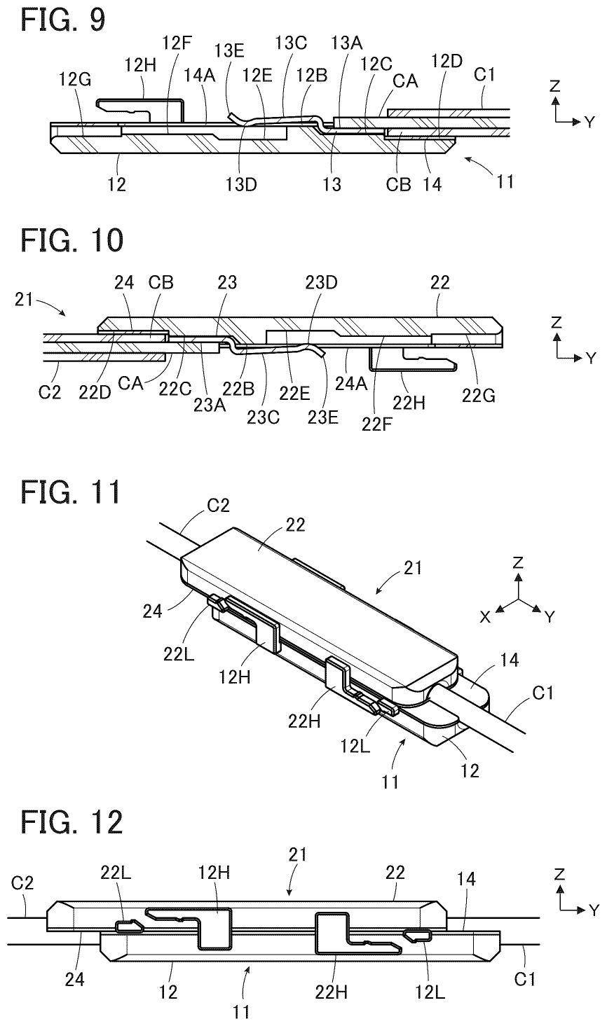

As shown in FIG. 9, a −Z directional part of the insulating coating portion CB near the −Y directional end portion of the first electric wire C1 is accommodated in the first electric wire accommodating groove 12D of the first insulator 12 via the first waterproof sheet 14, and the conductor portion CA exposed from the insulating coating portion CB is connected to the electric wire connection portion 13A of the first contact 13 by soldering, for example, within the opening portion 14A of the first waterproof sheet 14.

Note that the first protrusion portion 13D of the first contact 13 is situated on the +Z direction side of the recessed portion 12E of the first insulator 12 via the opening portion 14A of the first waterproof sheet 14, and the tip portion 13E of the first protrusion portion 13D is situated on the +Z direction side from the first joining surface 12B of the first insulator 12.

Here, FIG. 10 shows the second connector 21 to be fitted with the first connector 11. The second connector 21 has the same configuration as that of the first connector 11 and is fitted with the first connector 11 while oppositely facing in the X direction, the Y direction, and the Z direction from the first connector 11.

As shown in FIG. 10, in the second connector 21, a pair of leg portions of the second contact 23 are press-fitted into a recessed portion 22C, which forms part of the second contact accommodating portion, of the second insulator 22, whereby the second contact 23 is retained by the second insulator 22. In addition, a second waterproof sheet 24 is disposed on a second joining surface 22B of the second insulator 22.

A +Z directional part of the insulating coating portion CB near the +Y directional end portion of the second electric wire C2 is accommodated in a second electric wire accommodating groove 22D of the second insulator 22 via the second waterproof sheet 24, and the conductor portion CA exposed from the insulating coating portion CB is connected to an electric wire connection portion 23A of the second contact 23 by soldering, for example, within an opening portion 24A of the second waterproof sheet 24.

Note that a second protrusion portion 23D of the second contact 23 is situated on the −Z direction side of a recessed portion 22E of the second insulator 22 via the opening portion 24A of the second waterproof sheet 24, and a tip portion 23E of the second protrusion portion 23D is situated on the −Z direction side from the second joining surface 22B of the second insulator 22.

In addition, the second insulator 22 of the second connector 21 includes second locking portions 22H and second locked portions 22L to be described later that respectively have the same structures as those of the first locking portions 12H and the first locked portions 12L of the first insulator 12 of the first connector 11, each second locking portion 22H has a projection formed in its arm portion, and each second locked portion 22L has a projection.

When the connector assembly according to Embodiment 1 is assembled, first, as shown in FIG. 11, the second connector 21 is superposed on the first connector 11 on the +Z direction side thereof while oppositely facing in the X direction, the Y direction, and the Z direction from the first connector 11. At this time, in the state where the second waterproof sheet 24 of the second connector 21 makes contact with the first waterproof sheet 14 of the first connector 11, the second insulator 22 of the second connector 21 is disposed at a position apart from the first insulator 12 of the first connector 11 in the −Y direction by a predetermined distance.

Therefore, as shown in FIG. 12, the second locking portion 22H and the second locked portion 22L of the second connector 21 are respectively situated away from the first locked portion 12L and the first locking portion 12H of the first connector 11 in the −Y direction, and the first insulator 12 of the first connector 11 and the second insulator 22 of the second connector 21 are not locked by each other yet.

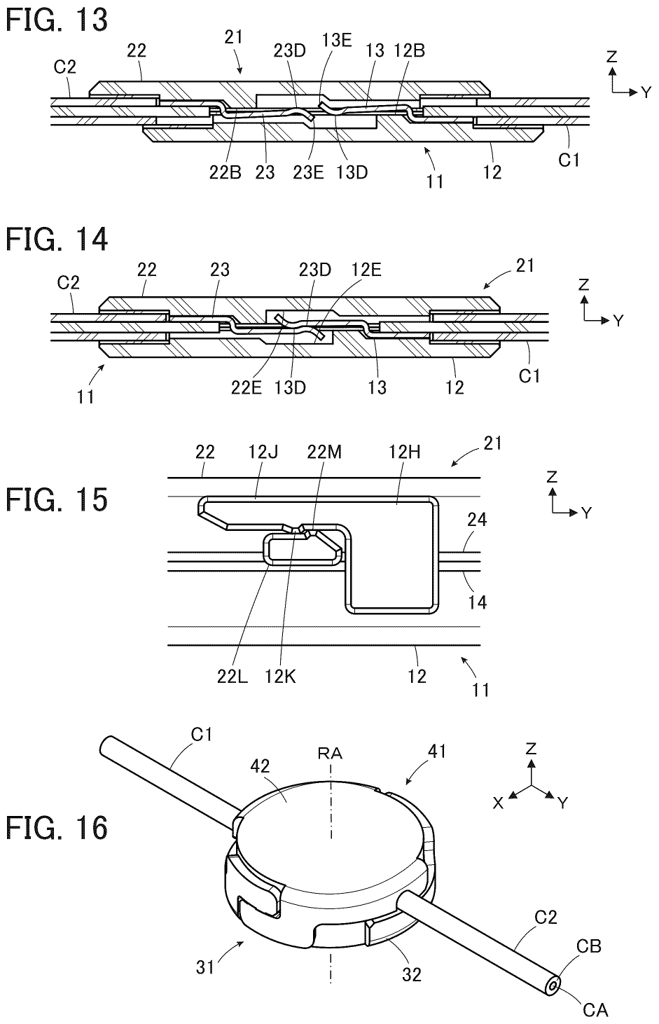

In addition, at this time, as shown in FIG. 13, the second contact 23 of the second connector 21 is situated away from the first contact 13 in the −Y direction and does not make contact with the first contact 13 of the first connector 11 yet.

The tip portion 13E of the first protrusion portion 13D of the first contact 13 in the first connector 11 is situated on the +Z direction side from the tip portion 23E of the second protrusion portion 23D of the second contact 23 in the second connector 21.

In this state, when the second connector 21 is linearly slid in the +Y direction relatively to the first connector 11 until the second insulator 22 of the second connector 21 is situated at the same Y directional position as that of the first insulator 12 of the first connector 11, as shown in FIG. 14, the first connector 11 and the second connector 21 are guided by the tip portion 13E of the first protrusion portion 13D of the first contact 13 and the tip portion 23E of the second protrusion portion 23D of the second contact 23 and moved relative to each other until the first protrusion portion 13D and the second protrusion portion 23D pass over each other. Thus, the first protrusion portion 13D of the first contact 13 is situated between the second contact 23 and the second insulator 22 of the second connector 21, while the second protrusion portion 23D of the second contact 23 is situated between the first contact 13 and the first insulator 12 of the first connector 11.

To be more specific, the first protrusion portion 13D of the first contact 13 is situated between the second protrusion portion 23D of the second contact 23 and the bottom surface of the recessed portion 22E of the second insulator 22, while the second protrusion portion 23D of the second contact 23 is situated between the first protrusion portion 13D of the first contact 13 and the bottom surface of the recessed portion 12E of the first insulator 12, and the first protrusion portion 13D of the first contact 13 and the second protrusion portion 23D of the second contact 23 make elastic contact with each other in the Z direction. Thus, the first connector 11 and the second connector 21 are fitted with each other, and the assembling operation of the connector assembly is completed.

The first protrusion portion 13D of the first contact 13 is situated between the second contact 23 and the second insulator 22 of the second connector 21, and the second protrusion portion 23D of the second contact 23 is situated between the first contact 13 and the first insulator 12 of the first connector 11; therefore, a contact force by which the first insulator 12 and the second insulator 22 are attracted to each other in the Z direction acts between the first contact 13 and the second contact 23. That is, a +Z directional contact force from the second protrusion portion 23D of the second contact 23 toward the second insulator 22 acts on the first protrusion portion 13D of the first contact 13, while a −Z directional contact force from the first protrusion portion 13D of the first contact 13 toward the first insulator 12 acts on the second protrusion portion 23D of the second contact 23.

When the first connector 11 and the second connector 21 are fitted with each other, the first contact 13 and the second contact 23 are electrically connected with each other, and the first electric wire C1 and the second electric wire C2 are electrically connected to each other via the first contact 13 and the second contact 23.

In addition, when the second connector 21 is linearly slid in the +Y direction relatively to the first connector 11 until the second insulator 22 of the second connector 21 is situated at the same Y directional position as that of the first insulator 12 of the first connector 11, as shown in FIG. 3, the first locked portion 12L of the first insulator 12 is locked by the second locking portion 22H of the second insulator 22, while the second locked portion 22L of the second insulator 22 is locked by the first locking portion 12H of the first insulator 12, whereby the first insulator 12 and the second insulator 22 are fixed to each other.

When the second locked portion 22L of the second insulator 22 is locked by the first locking portion 12H of the first insulator 12, as shown in FIG. 15, the projection 22M of the second locked portion 22L catches the projection 12K of the arm portion 12J of the first locking portion 12H. Although not shown in the drawings, similarly, the projection 12M of the first locked portion 12L catches the projection of the arm portion of the second locking portion 22H. This constitution effectively suppresses releasing of the fitted state due to linear advancement of the second connector 21 in the fitted state in the −Y direction from the first connector 11.

Since the first protrusion portion 13D of the first contact 13 and the second protrusion portion 23D of the second contact 23 pass over each other when the first connector 11 and the second connector 21 are fitted with each other, the constitution where the first protrusion portion 13D and the second protrusion portion 23D interfere with each other also suppresses releasing of the fitted state due to shifting of the second connector 21 in the −Y direction from the first connector 11.

In the connector assembly of Embodiment 1, a contact force by which the first insulator 12 and the second insulator 22 are attracted to each other in the Z direction acts between the first contact 13 and the second contact 23, thereby reducing strength and durability required for each of the first locking portion 12H, the first locked portion 12L, the second locking portion 22H, the second locked portion 22L that are used to fix the first insulator 12 and the second insulator 22 to each other. As a result, it is possible to reduce the size of the connector assembly.

In addition, the first waterproof sheet 14 is disposed on the first joining surface 12B of planar shape of the first insulator 12, and the −Z directional part of the insulating coating portion CB near the −Y directional end portion of the first electric wire C1 is accommodated in the first electric wire accommodating groove 12D of the first insulator 12 via the first waterproof sheet 14; similarly, the second waterproof sheet 24 is disposed on the second joining surface 22B of planar shape of the second insulator 22, and a +Z directional part of the insulating coating portion CB near the +Y directional end portion of the second electric wire C2 is accommodated in the second electric wire accommodating groove 22D of the second insulator 22 via the second waterproof sheet 24. Accordingly, when the first connector 11 and the second connector 21 are fitted with each other, the first waterproof sheet 14 situated on the first joining surface 12B and the second waterproof sheet 24 situated on the second joining surface 22B are pressed against each other in the Z direction. Therefore, a waterproof structure can be easily formed by means of the first waterproof sheet 14 and the second waterproof sheet 24 each made of a rubber material or the like.

In addition, when the first connector 11 and the second connector 21 in the fitted state are linearly slid in an opposite direction from the fitting operation by a force by which the projection 12K of the first locking portion 12H and the projection of the second locking portion 22H pass over the projection 22M of the second locked portion 22L and the projection 12M of the first locked portion 12L, respectively, the first connector 11 and the second connector 21 can be detached from each other.

### Embodiment 2

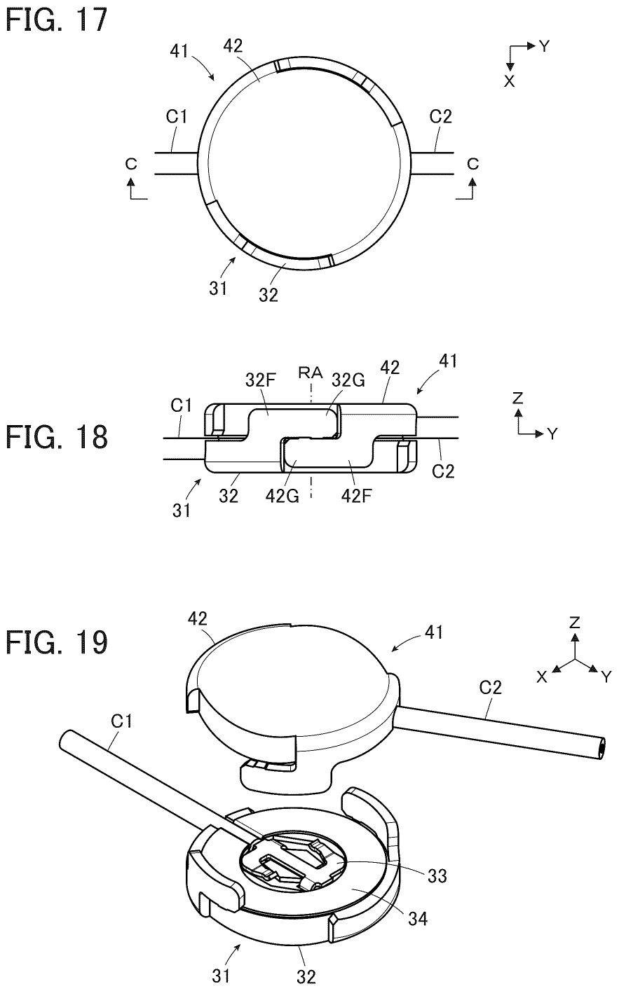

FIGS. 16 to 18 show a connector assembly according to Embodiment 2. The connector assembly includes a first connector 31 and a second connector 41, and when the second connector 41 is rotated and slid about a rotational axis RA relatively to the first connector 31, the first connector 31 and the second connector 41 are fitted with each other, and the first electric wire C1 and the second electric wire C2 are electrically connected to each other.

The first connector 31 is joined to a +Y directional end portion of the first electric wire C1, while the second connector 41 is joined to a −Y directional end portion of the second electric wire C2. The first electric wire C1 and the second electric wire C2 are the same as those used in Embodiment 1, are each formed of a coated electric wire in which an outer periphery of a conductor portion CA is covered with an insulating coating portion CB, and extend in opposite directions from each other on the same straight line.

The first connector 31 includes a first insulator 32 of substantially circular disk shape, and similarly, the second connector 41 includes a second insulator 42 of substantially circular disk shape. The first connector 31 and the second connector 41 are fitted with each other with the second insulator 42 being superposed on the first insulator 32.

The rotational axis RA passes the center of the first insulator 32 and the second insulator 42 each having a substantially circular disk shape and extends in the Z direction.

FIG. 19 shows the connector assembly of Embodiment 2 in a non-fitted state. The first connector 31 and the second connector 41 have the same configuration and are each hermaphroditically formed. The second connector 41 is rotated by a predetermined angle in an XY plane with respect to the first connector 31 at the start of fitting of the second connector 41 with the first connector 31, and at the time of completion of fitting, the second connector 31 is situated to oppositely face in the X direction, the Y direction, and the Z direction from the first connector 31.

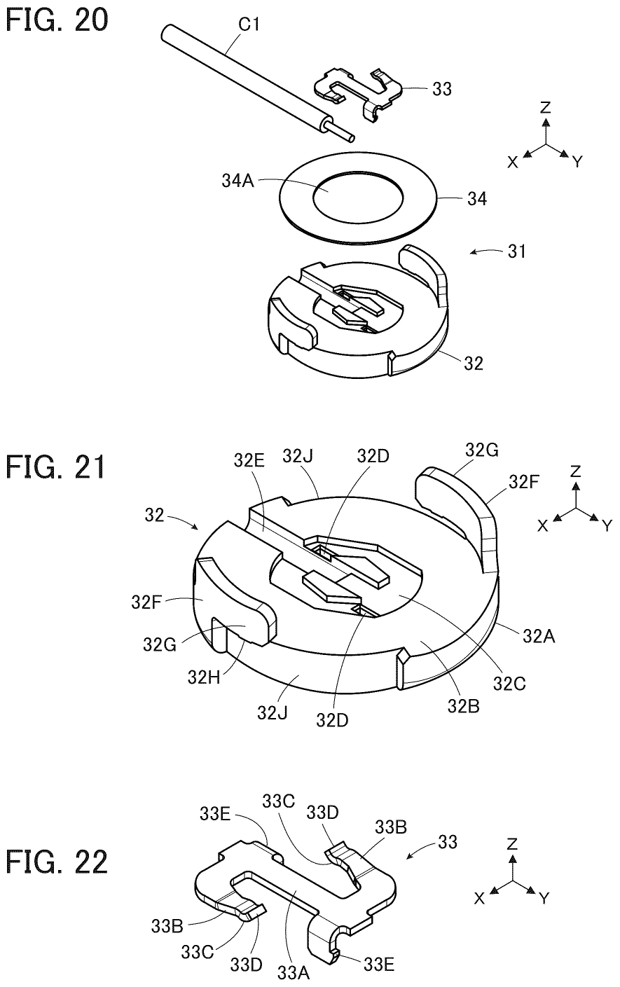

FIG. 20 shows an assembly view of the first connector 31. A first waterproof sheet 34 is disposed on the +Z direction side of the first insulator 32, the first electric wire C1 is disposed on the +Z direction side of the first waterproof sheet 34, and the first contact 33 is disposed on the +Z direction side of the first electric wire C1.

The first waterproof sheet 34 has a ring shape and is provided at the center thereof with a circular opening portion 34A when viewed from the +Z direction. In addition, at the +Y directional end portion of the first electric wire C1, the insulating coating portion CB is removed to expose the conductor portion CA, the exposed conductor portion CA of the first electric wire C1 is situated on the +Z direction side of the opening portion 34A of the first waterproof sheet 34, and the first contact 33 is situated on the +Z direction side of the exposed conductor portion CA of the first electric wire C1.

As shown in FIG. 21, the first insulator 32 is made of an insulating resin and includes a circular plate portion 32A of substantially circular shape extending along an XY plane. The circular plate portion 32A has a first joining surface 32B of planar shape facing in the +Z direction, and a first contact accommodating portion 32C of recess shape formed in the first joining surface 32B and opening in the +Z direction.

The first contact accommodating portion 32C is formed at the center of the circular plate portion 32A and is configured to accommodate and retain the first contact 33. The first contact accommodating portion 32C is provided with a pair of press-fitting holes 32D in which part of the first contact 33 is press-fitted.

In addition, the first joining surface 32B is provided with a first electric wire accommodating groove 32E extending in the Y direction from the first contact accommodating portion 32C to a −Y directional end portion of the circular plate portion 32A.

The periphery of the first contact accommodating portion 32C is completely surrounded by the first joining surface 32B of planar shape and the first electric wire accommodating groove 32E.

At lateral portions of the circular plate portion 32A, a pair of first locking portions 32F are separately formed to protrude in the +Z direction. The pair of first locking portions 32F are situated on one diameter of the circular plate portion 32A and face each other, and separately include arm portions 32G extending along the circumference of the circular plate portion 32A on the +Z direction side from the first joining surface 32B. The arm portions 32G of the pair of first locking portions 32F extend in the same rotational direction about the center of the circular plate portion 32A and are curved along the circumference of the circular plate portion 32A.

At an intermediate portion of the arm portion 32G in the circumferential direction of the circular plate portion 32A, a projection 32H is formed to protrude in the −Z direction.

Further, at lateral portions of the circular plate portion 32A, a pair of reduced diameter portions 32J are separately formed to be adjacent to the pair of first locking portions 32F and be recessed toward the center of the circular plate portion 32A. Each reduced diameter portion 32J extends from the −Z direction side of the arm portion 32G of the corresponding first locking portion 32F to the rotational position beyond the tip of the arm portion 32G along the circumferential direction of the circular plate portion 32A.

As shown in FIG. 22, the first contact 33 is formed of a metal sheet having conductivity and being bent and includes an electric wire connection portion 33A elongated in the Y direction along an XY plane, and a pair of extending portions 33B extending along an XY plane separately from a +Y directional end portion and a −Y directional end portion of the electric wire connection portion 33A.

The extending portion 33B joined to the +Y directional end portion of the electric wire connection portion 33A extends in the −X direction from the +Y directional end portion of the electric wire connection portion 33A along an XY plane and then extends in the −Y direction, and at a −Y directional end portion of the extending portion 33B, a first protrusion portion 33C is formed to be curved so as to protrude in the −Z direction. Further, a −Y directional tip portion 33D of the first protrusion portion 33C is inclined in the −Y direction and the +Z direction.

On the other hand, the extending portion 33B joined to the −Y directional end portion of the electric wire connection portion 33A extends in the +X direction from the −Y directional end portion of the electric wire connection portion 33A along an XY plane and then extends in the +Y direction, and at a +Y directional end portion of the extending portion 33B, a first protrusion portion 33C is formed to be curved so as to protrude in the −Z direction. Further, a +Y directional tip portion 33D of the first protrusion portion 33C is inclined in the +Y direction and the +Z direction.

Further, the first contact 33 has a pair of press-fitting portions 33E extending in the −Z direction separately from the +Y directional end portion and the −Y directional end portion of the electric wire connection portion 33A.

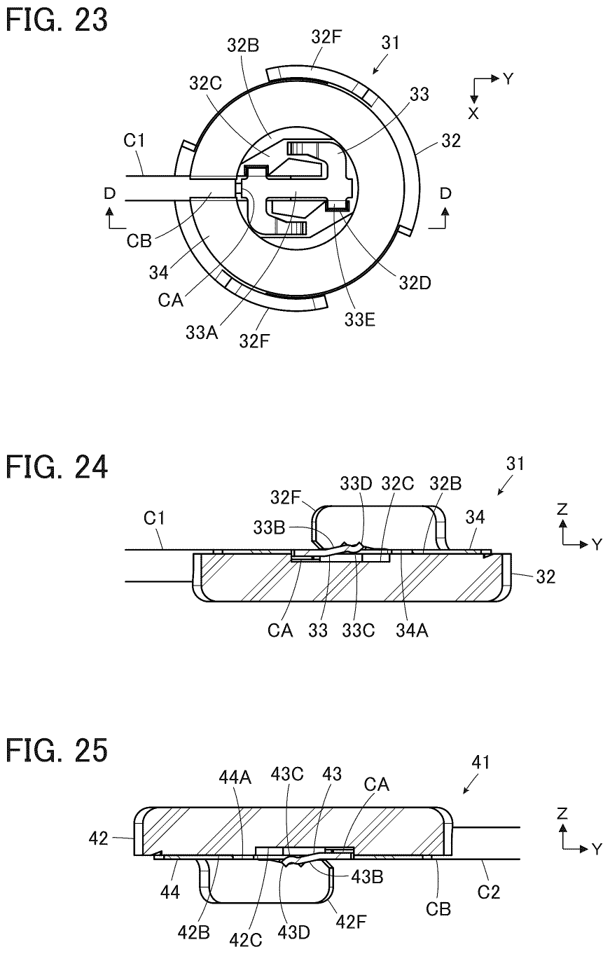

As shown in FIG. 23, in the first connector 31, the first waterproof sheet 34 made of a rubber material or the like is disposed on the first joining surface 32B of the first insulator 32.

Part of the conductor portion CA exposed from the insulating coating portion CB near a +Y directional end portion of the first electric wire C1 is connected to a −Z directional surface of the electric wire connection portion 33A of the first contact 33 by, for example, soldering, and the first contact 33 is accommodated in the first contact accommodating portion 32C of the first insulator 32. When the pair of press-fitting portions 33E are separately press-fitted into the pair of press-fitting holes 32D of the first contact accommodating portion 32C, the first contact 33 is fixed to the first insulator 32.

In addition, part of the insulating coating portion CB near the +Y directional end portion of the first electric wire C1 is accommodated in the first electric wire accommodating groove 32E of the first insulator 32 shown in FIG. 21 via the first waterproof sheet 34.

As shown in FIG. 24, the pair of first protrusion portions 33C separately formed in the pair of extending portions 33B of the first contact 33 are disposed on the +Z direction side of the first contact accommodating portion 32C of the first insulator 32 via the opening portion 34A of the first waterproof sheet 34, and the tip portion 33D of each of the first protrusion portions 33C is situated on the +Z direction side from the first joining surface 32B of the first insulator 32.

Here, FIG. 25 shows the second connector 41 to be fitted with the first connector 31. The second connector 41 has the same configuration as that of the first connector 31 and is fitted with the first connector 31 while oppositely facing in the X direction, the Y direction, and the Z direction from the first connector 31.

In the second connector 41, a second contact 43 is accommodated in a second contact accommodating portion 42C of the second insulator 42, and a second waterproof sheet 44 is disposed on a second joining surface 42B of the second insulator 42.

Part of the conductor portion CA exposed from the insulating coating portion CB near a −Y directional end portion of the second electric wire C2 is connected to the second contact 43 by, for example, soldering.

A pair of second protrusion portions 43C separately formed at a pair of extending portions 43B of the second contact 43 are situated on the −Z direction side of the second contact accommodating portion 42C of the second insulator 42 via an opening portion 44A of the second waterproof sheet 44, and a tip portion 43D of each of the second protrusion portions 43C is situated on the −Z direction side from the second joining surface 42B of the second insulator 42.

In addition, the second insulator 42 of the second connector 41 includes a pair of second locking portions 42F having the same structure as that of the first locking portions 32F of the first insulator 32 of the first connector 31, and each second locking portion 42F includes a projection 42H formed at an arm portion 42G to be described later.

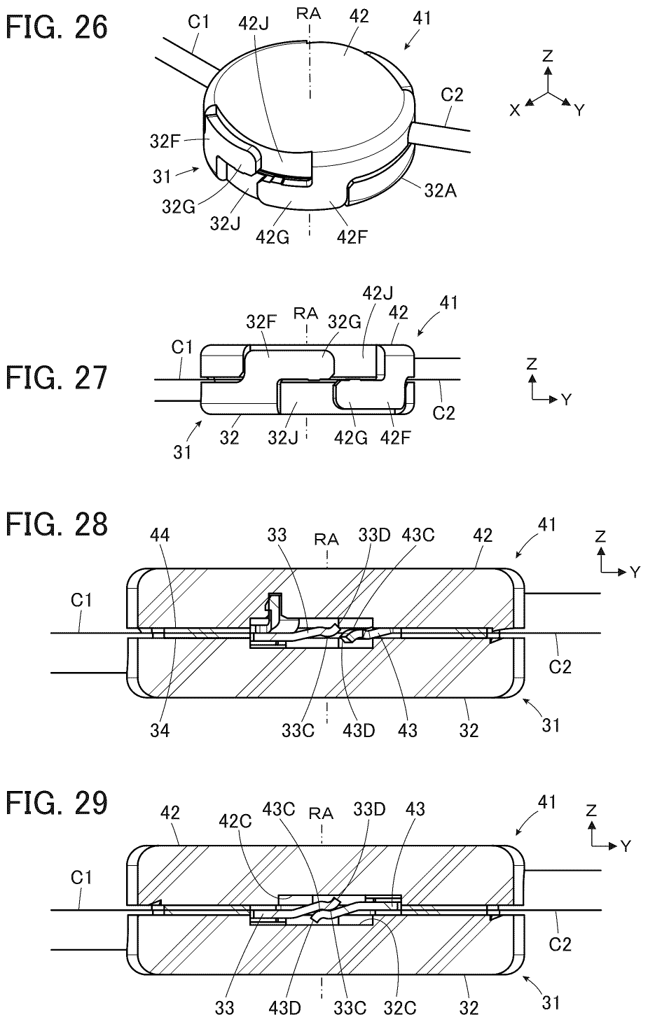

When the connector assembly according to Embodiment 2 is assembled, first, as shown in FIG. 26, the second connector 41 is superposed on the first connector 31 on the +Z direction side thereof so as to oppositely face in the Z direction from the first connector 31. With the second connector 41 being situated at such a rotational position that the second electric wire C2 joined to the second connector 41 extends in a direction rotated from the Y direction about the rotational axis RA by a predetermined angle, the arm portion 42G of the second locking portion 42F of the second insulator 42 is situated along an outer peripheral portion of the reduced diameter portion 32J of the first insulator 32, and the arm portion 32G of the first locking portion 32F of the first insulator 32 is situated along an outer peripheral portion of the reduced diameter portion 42J of the second insulator 42; in this state, the second connector 41 can be superposed on the first connector 31 on the +Z direction side thereof.

At this time, as shown in FIG. 27, the arm portion 32G of the first locking portion 32F and the arm portion 42G of the second locking portion 42F are situated at rotational positions different from each other in the rotational direction about the rotational axis RA, and the first insulator 32 of the first connector 31 and the second insulator 42 of the second connector 41 are not locked by each other yet.

In addition, at this time, as shown in FIG. 28, the second contact 43 of the second connector 41 is situated away from the first contact 33 in the rotational direction about the rotational axis RA and does not make contact with the first contact 33 of the first connector 31 yet.

The tip portion 33D of the first protrusion portion 33C of the first contact 33 in the first connector 31 is situated on the +Z direction side from the tip portion 43D of the second protrusion portion 43C of the second contact 43 in the second connector 41.

Further, when the second connector 41 is superposed on the first connector 31 on the +Z direction side thereof, the second waterproof sheet 44 of the second connector 41 makes contact with the first waterproof sheet 34 of the first connector 31.

In this state, when the second connector 41 is rotated and slid about the rotational axis RA relatively to the first connector 31 until the direction in which the second electric wire C2 joined to the second connector 41 extends coincides with the Y direction, as shown in FIG. 29, the first connector 31 and the second connector 41 are guided by the tip portions 33D of the pair of the first protrusion portions 33C formed in the pair of extending portions 33B of the first contact 33 and the tip portions 43D of the pair of second protrusion portions 43C formed in the pair of extending portions 43B of the second contact 43, and are moved relative to each other until the first protrusion portions 33C and the second protrusion portions 43C pass over each other. Thus, the pair of first protrusion portions 33C of the first contact 33 are situated between the second contact 43 and the second insulator 42 of the second connector 41, while the pair of second protrusion portions 43C of the second contact 43 are situated between the first contact 33 and the first insulator 32 of the first connector 31.

To be more specific, each first protrusion portion 33C of the first contact 33 is situated between the corresponding second protrusion portion 43C of the second contact 43 and the bottom surface of the second contact accommodating portion 42C of the second insulator 42, while each second protrusion portion 43C of the second contact 43 is situated between the corresponding first protrusion portion 33C of the first contact 33 and the bottom surface of the first contact accommodating portion 32C of the first insulator 32, and the first protrusion portion 33C of the first contact 33 and the second protrusion portion 43C of the second contact 43, which correspond to each other, make elastic contact with each other in the Z direction. Thus, the first connector 31 and the second connector 41 are fitted with each other, and the assembling operation of the connector assembly is completed.

The first protrusion portion 33C of the first contact 33 is situated between the second contact 43 and the second insulator 42 of the second connector 41, and the second protrusion portion 43C of the second contact 43 is situated between the first contact 33 and the first insulator 32 of the first connector 31; therefore, a contact force by which the first insulator 32 and the second insulator 42 are attracted to each other in the Z direction acts between the first contact 33 and the second contact 43. That is, a +Z directional contact force from the second protrusion 43C of the second contact 43 toward the second insulator 42 acts on the first protrusion portion 33C of the first contact 33, while a −Z directional contact force from the first protrusion portion 33C of the first contact 33 toward the first insulator 32 acts on the second protrusion portion 43C of the second contact 43.

When the first connector 31 and the second connector 41 are fitted with each other, the first contact 33 and the second contact 43 are electrically connected with each other, and the first electric wire C1 and the second electric wire C2 are electrically connected to each other via the first contact 33 and the second contact 43.

In addition, when the second connector 41 is rotated and slid about the rotational axis RA relatively to the first connector 31 until a direction in which the second electric wire C2 joined to the second connector 41 extends coincides with the Y direction, as shown in FIG. 18, the arm portion 32G of the first locking portion 32F of the first insulator 32 and the arm portion 42G of the second locking portion 42F of the second insulator 42 are situated to be superposed on each other in the Z direction. Thus, the first locking portion 32F and the second locking portion 42F interfere with each other, and the first insulator 32 and the second insulator 42 are locked by and fixed with each other.

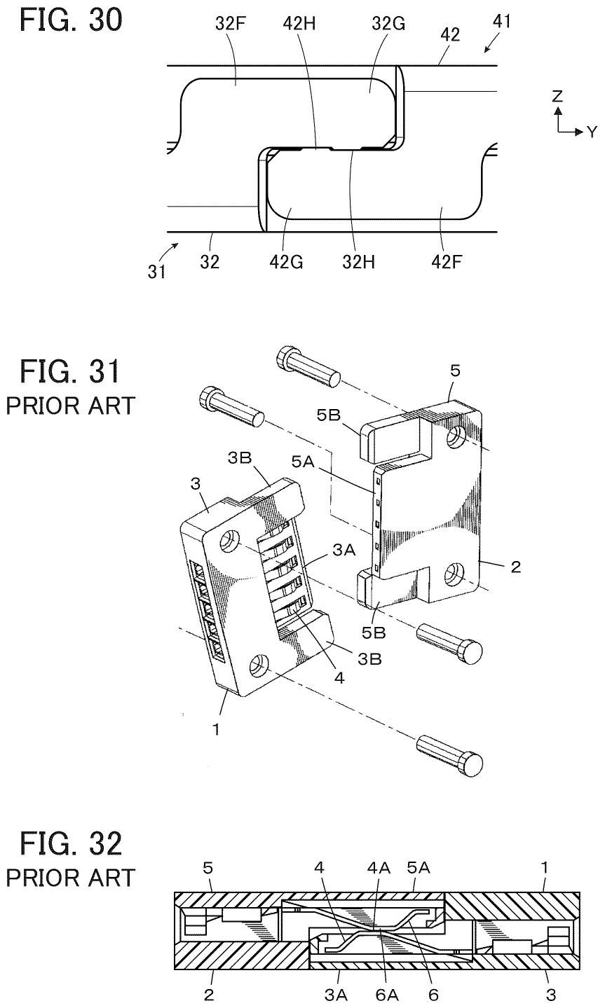

When the first insulator 32 and the second insulator 42 are locked by each other in this manner, as shown in FIG. 30, the projection 32H of the arm portion 32G of the first locking portion 32F catches the projection 42H of the arm portion 42G of the second locking portion 42F. This constitution effectively suppresses releasing of the fitted state due to rotation of the second connector 41 in the fitted state about the rotational axis RA with respect to the first connector 31.

Since the first protrusion portion 33C of the first contact 33 and the second protrusion portion 43C of the second contact 43 pass over each other in a fitting process between the first connector 31 and the second connector 41, the constitution where the first protrusion portion 33C and the second protrusion portion 43C interfere with each other also suppresses releasing of the fitted state due to rotation of the second connector 41 about the rotational axis RA with respect to the first connector 31.

As with the connector assembly of Embodiment 1, also in the connector assembly of Embodiment 2, a contact force by which the first insulator 32 and the second insulator 42 are attracted to each other in the Z direction acts between the first contact 33 and the second contact 43, thereby reducing strength and durability required for each of the first locking portion 32F and the second locking portion 42F that are used to fix the first insulator 32 and the second insulator 42 to each other. As a result, it is possible to reduce the size of the connector assembly.

In addition, the first waterproof sheet 34 is disposed on the first joining surface 32B of planar shape of the first insulator 32, and part of the insulating coating portion CB near the +Y directional end portion of the first electric wire C1 is accommodated in the first electric wire accommodating groove 32E of the first insulator 32 via the first waterproof sheet 34; similarly, the second waterproof sheet 44 is disposed on the second joining surface 42B of planar shape of the second insulator 42, and part of the insulating coating portion CB near the −Y directional end portion of the second electric wire C2 is accommodated in the second electric wire accommodating groove of the second insulator 42 via the second waterproof sheet 44. Accordingly, when the first connector 31 and the second connector 41 are fitted with each other, the first waterproof sheet 34 situated on the first joining surface 32B and the second waterproof sheet 44 situated on the second joining surface 42B are pressed against each other in the Z direction. Therefore, a waterproof structure can be easily formed by means of the first waterproof sheet 34 and the second waterproof sheet 44 each made of a rubber material or the like.

In Embodiment 2 above, the first contact 33 includes the pair of first protrusion portions 33C, while the second contact 43 includes the pair of second protrusion portions 43C, but the invention is not limited thereto, and the connector assembly may be configured such that only one first protrusion portion 33C included in the first contact 33 and only one second protrusion portion 43C included in the second contact 43 make elastic contact with each other in the Z direction.

Meanwhile, as described in Embodiment 2 above, when the first contact 33 and the second contact 43 make contact with each other at two points by means of the pair of first protrusion portions 33C and the pair of second protrusion portions 43C, the reliability of the electric connection can be improved.

In addition, when the first connector 31 and the second connector 41 in the fitted state are rotated and slid in an opposite direction from the fitting operation by a force by which the projection 32H of the first locking portion 32F passes over the projection 42H of the second locking portion 42F, the first connector 31 and the second connector 41 can be detached from each other.

In the connector assembly of each of Embodiments 1 and 2 above, since the first electric wire C1 and the second electric wire C2 are electrically connected with each other by means of the first connector 11, 31 and the second connector 21, 41, by only fitting and detaching the first connector 11, 31 and the second connector 21, 41 with and from each other, connection and blocking between the first electric wire C1 and the second electric wire C2 can be easily switched.

Further, since the first connector 11, 31 and the second connector 21, 41 have the same configuration and are each hermaphroditically formed, the production cost of the connector assembly can be reduced, and erroneous connection of the end portion of the first electric wire C1 and the end portion of the second electric wire C2 with the connectors can be prevented, so electrical connection between the first electric wire C1 and the second electric wire C2 can be reliably established.

What is claimed is:

1. A connector assembly in which a first connector and a second connector are fitted with each other, the first connector being joined to an end portion of a first electric wire, and the second connector being joined to an end portion of a second electric wire and having a same configuration as that of the first connector,
wherein the first connector includes a first insulator, and a first contact retained by the first insulator and connected to the end portion of the first electric wire,
the second connector includes a second insulator, and a second contact retained by the second insulator and connected to the end portion of the second electric wire, and
when the first connector and the second connector are fitted with each other, the first contact and the second contact make contact with each other in a state where part of the first contact is situated between the second contact and the second insulator and part of the second contact is situated between the first contact and the first insulator, whereby the first electric wire and the second electric wire are electrically connected to each other.

2. The connector assembly according to claim 1,
wherein the first insulator includes a first joining surface of planar shape and a first contact accommodating portion of recess shape which is formed in the first joining surface and in which at least part of the first contact is accommodated, and
the second insulator includes a second joining surface of planar shape facing the first joining surface and a second contact accommodating portion of recess shape which is formed in the second joining surface and in which at least part of the second contact is accommodated.

3. The connector assembly according to claim 2, wherein the first connector and the second connector are moved relative to each other along the second joining surface and the first joining surface to thereby be fitted with each other.

4. The connector assembly according to claim 3,
wherein the first contact includes a first protrusion portion protruding in an opposite direction from the second connector,
the second contact includes a second protrusion portion protruding in an opposite direction from the first connector, and
the first connector and the second connector are moved relative to each other until the first protrusion portion and the second protrusion portion pass over each other.

5. The connector assembly according to claim 3, wherein the first connector and the second connector are moved relative to each other so as to be linearly slid with respect to each other.

6. The connector assembly according to claim 3, wherein the first connector and the second connector are moved relative to each other so as to be rotated and slid with respect to each other.

7. The connector assembly according to claim 2, comprising a waterproof portion sandwiched between the first joining surface and the second joining surface.

8. The connector assembly according to claim 7, wherein the waterproof portion is constituted of a first waterproof sheet disposed on the first joining surface and a second waterproof sheet disposed on the second joining surface and closely adhered to the first waterproof sheet.

9. The connector assembly according to claim 2,
wherein each of the first electric wire and the second electric wire is constituted of a coated electric wire in which an outer peripheral portion of a conductor portion is covered with an insulating coating portion,
the conductor portion at the end portion of the first electric wire is connected to the first contact in the first contact accommodating portion, and
the conductor portion at the end portion of the second electric wire is connected to the second contact in the second contact accommodating portion.

10. The connector assembly according to claim 9,
wherein the first insulator has a first electric wire accommodating groove which is formed in the first joining surface so as to communicate with the first contact accommodating portion and in which part of the first electric wire is accommodated, and
the second insulator has a second electric wire accommodating groove which is formed in the second joining surface so as to communicate with the second contact accommodating portion and in which part of the second electric wire is accommodated.

11. The connector assembly according to claim 1,
wherein the first insulator includes a first locking portion and a first locked portion,
the second insulator includes a second locking portion and a second locked portion, and
when the first connector and the second connector are fitted with each other, the first locked portion is locked by the second locking portion, and the second locked portion is locked by the first locking portion, whereby the first insulator and the second insulator are fixed to each other.

12. The connector assembly according to claim 1,
wherein the first insulator includes a first locking portion,
the second insulator includes a second locking portion, and
when the first connector and the second connector are fitted with each other, the first locking portion and the second locking portion interfere with each other, whereby the first insulator and the second insulator are fixed to each other.
